(19) United States
(12) Patent Application Publication
(10) Pub. No.: US 2016/0261818 A1
(43) Pub. Date: Sep. 8, 2016

(54) CURSOR CONTROL METHOD AND CURSOR CONTROL DEVICE OF SMART TV

(71) Applicant: LE SHI ZHI XIN ELECTRONIC TECHNOLOGY (TIANJIN) LIMITED, Beijing (CN)

(72) Inventors: Shuyin DU, Beijing (CN); Xue ZHANG, Beijing (CN)

(21) Appl. No.: 15/032,610

(22) PCT Filed: Oct. 29, 2014
(86) PCT No.: PCT/CN2014/089809

§ 371 Date: Apr. 27, 2016

(30) Foreign Application Priority Data
Oct. 31, 2013 (CN) 201310526523.5

(51) Int. Cl. H04N 5/44; G06F 3/023; H04N 21/422; G06F 3/0481

(52) U.S. Cl. CPC H04N 5/4403; G06F 3/04812; G06F 3/0237; H04N 21/42204; H04N 21/42214; H04N 2005/4419

(57) ABSTRACT

A cursor control method and cursor control device of a smart TV, wherein when a character inputting box in a character inputting interface is in a non-editing state, the method includes the following steps: receiving and resolving a control signal from a remote control; triggering the character inputting box into an editable state if the control signal instructs to move the cursor into the character inputting box; judging whether a string exists in the character inputting box; if the judgement result is yes, judging a target position in the string where an input error may exist; and positioning the cursor at the target position in the string. The cursor control method and cursor control device of a smart TV in the present disclosure can make modification of strings existed in the character inputting box is more convenient, thereby improving modification efficiency and saving input operation cost for users.

### CROSS-REFERENCE TO RELATED APPLICATIONS

The present disclosure is a national stage of International Application No. PCT/CN2014/089809, filed Oct. 29, 2014, which is based upon and claims the priority of the Chinese patent application filed to State Intellectual Property Office of China by the application number of 2013105265235 at Oct. 31, 2013 and entitled “CURSOR CONTROL METHOD AND CURSOR CONTROL DEVICE OF smart TV”, the entire content of all of which is incorporated herein by reference.

### FIELD OF TECHNOLOGY

The present disclosure generally relates to field of smart TVs, and especially to a cursor control method and cursor control device of a smart TV.

### BACKGROUND

In case that personal computers (PCs) have already been intelligent and mobile phones and tablets have largely been intelligent, smart TVs also gradually be used in our life in order to follow the trend of “high-definition”, “networking” and “intelligence” of televisions.

The so-called smart TV, like the smartphone, has a completely open platform and a built-in operating system. In addition to watch normal programs in the television, the customer can, by himself/herself, install and uninstall programs such as an application software and a game provided by the television manufacturer or the third-party service provider. The functions of the smart TV can be continuously expanded and updated by such programs. Further, the smart TV can be connected to a network, an AV device, a PC, etc., and acquires program contents by multiple ways, such as the network, the AV device, the PC, etc. The content that the user needs most may be clearly displayed on the screen of the TV via a simple and easy integrated operation interface. With the use of more and more application software and network functions, significant amount of man-machine interactive operations occurs, i.e., the user needs to input characters to finish the operations, e.g., inputting web addresses, inputting texts and inputting passwords.

On existing smart TVs, the process for inputting characters is generally as follows: in a character inputting interface, moving the cursor into a character inputting box by a remote control, while displaying a soft keyboard in the character inputting interface; inputting by controlling the soft keyboard via the remote control; and after finishing inputting, by pushing the “confirmation” key on the remote control or clicking “Enter” on the soft keyboard, transforming the character inputting interface from an editing state into a non-editing state, i.e., hiding the soft keyboard, so that the editing operations for the characters such as selection, modification and inputting cannot be performed.

When the user needs to modify the characters existed in the character inputting box, the cursor would be moved into the character inputting box again via the remote control, and the character inputting interface is transformed into an editable state from the non-editing state, i.e., editing operations for the characters such as selection, modification and inputting can be performed. However, in the prior art, all the characters in the text input box are generally selected by default now.

If the user needs to modify, the only way is to delete all the selected characters first by clicking “Delete” on the soft keyboard via the remote control and then input again.

However, since inputting characters through remote control operations is a relatively inconvenient operation itself, it will be a quite cumbersome process to re-input all characters once at each time of modification. This needs significant cost for manual input.

Hence, the technical problem to be urgently solved by persons skilled in the art is the inconvenience in modifying the characters existed in the character inputting box in existing smart TVs.

### SUMMARY

One of the technical problems to be solved in the present disclosure is to provide a cursor control method and cursor control device of a smart TV, so that the modification of the characters existed in the character inputting box is more convenient, thereby improving the modification efficiency, providing convenience for user operations and saving input operation cost for users.

To achieve the objective above, according to an aspect of the present disclosure, there is provided a cursor control method of a smart TV, characterized in that, when a character inputting box in a character inputting interface is in a non-editing state, said method includes:

receiving and resolving a control signal from a remote control;

triggering said character inputting box into an editable state if the control signal instructs to move a cursor into said character inputting box;

judging whether a string exists in said character inputting box;

performing error positioning on the string in said character inputting box if the judgement result is yes, thus determining a target position in said string where an input error may exist; and

positioning said cursor at said target position in the string.

In an embodiment of the present disclosure, the method further includes:

positioning said cursor at the forefront end in said character inputting box if the judgment result is no.

In an embodiment of the present disclosure, said performing error positioning on the string in the character inputting box further includes:

determining a string type of said string in said character inputting box according to a preset feature of a certain string type; and

performing error positioning on said string according to said error positioning feature corresponding to respective preset string type.

In an embodiment of the present disclosure, before positioning said cursor at said target position in said string, the method further includes:

providing a prompt of the information about said target position obtained from the error positioning to a user and asking said user whether it is necessary to move said cursor to said target position; and

triggering an operation of displaying said cursor at said target position in the string if a confirmation message is received from said user.

In an embodiment of the present disclosure, said performing error positioning on said string contained in said character inputting box further includes:

determining that the right side of the last character in said string is said target position.

In an embodiment of the present disclosure, said control signal is triggered by a key on said remote control or triggered by a touch screen of said remote control.

To achieve the objectives above, according to another aspect of the present disclosure, there is provided a cursor control device applied to a smart TV, an initial state of a character inputting box in a character inputting interface is in a non-editing state,

said device includes:

a resolving module for receiving and resolving a control signal from a remote control;

a first triggering module for triggering said character inputting box into an editable state if the control signal instructs to move a cursor into said character inputting box;

a judging module for judging whether a string exists in said character inputting box;

an error positioning module for performing error positioning on said string in said character inputting box if the judgement result is yes, thereby determining a target position in said string where an input error may exist; and

a first cursor positioning module for positioning said cursor at said target position in said string.

In an embodiment of the present disclosure, said error positioning module includes:

a string type determining module for determining a string type of said string in said character inputting box according to a preset feature of a certain string type; and

a string error positioning module for performing error positioning on the string according to the error positioning feature corresponding to respective preset string type.

In an embodiment of the present disclosure, said device further includes:

a prompting module for providing a prompt of the information about said target position obtained from the error positioning to said user and asking said user whether it is necessary to move said cursor to said target position; and

a second triggering module for triggering an operation of displaying said cursor at said target position in said string if a confirmation message is received from said user.

In an embodiment of the present disclosure, said error positioning module is further used for:

determining that the right side of the last character in said string is said target position.

There is further provided a non-transitory computer-readable recording medium having computer programs stored thereon that, when executed by one or more processors of a smart TV, cause the smart TV to perform:

receiving and resolving a control signal from a remote control;

triggering said character inputting box into an editable state if the control signal instructs to move a cursor into said character inputting box;

judging whether a string exists in said character inputting box;

performing error positioning on the string in said character inputting box if the judgement result is yes, thus determining a target position in said string where an input error may exist; and

positioning said cursor at said target position in the string.

There is further provided a smart TV, characterized in that, an initial state of a character inputting box in a character inputting interface is in a non-editing state,

said smart TV includes:

a memory having instructions stored thereon;

a processor configured to execute the instructions to perform operations of cursor control, including:

receiving and resolving a control signal from a remote control;

triggering said character inputting box into an editable state if the control signal instructs to move a cursor into said character inputting box;

judging whether a string exists in said character inputting box;

performing error positioning on said string in said character inputting box if the judgement result is yes, thereby determining a target position in said string where an input error may exist; and

positioning said cursor at said target position in said string.

Compared with the prior art, one of the above technical solutions has following advantages or beneficial effects that:

the cursor control method and cursor control device of a smart TV provided in the present disclosure can first determines, in the character inputting interface, the target position in the string where an input error may exist by performing error positioning on the string in the character inputting box, and then positions the cursor at the target position in the string, so that the modification of strings existed in the character inputting box is more convenient, thereby improving modification efficiency, providing convenience for user operations and saving input operation cost for users.

### BRIEF DESCRIPTION OF THE DRAWINGS

FIG. 1 is a flow diagram of an embodiment of a cursor control method of a smart TV in the present disclosure;

FIG. 2 is a first schematic diagram of a character inputting interface in the embodiment illustrated in FIG. 1;

FIG. 3 is a second schematic diagram of a character inputting interface in the embodiment illustrated in FIG. 1;

FIG. 4 is a third schematic diagram of a character inputting interface in the embodiment illustrated in FIG. 1;

FIG. 5 is a structural schematic diagram of an embodiment of a cursor control device of a smart TV in the present disclosure.

### DESCRIPTION OF THE EMBODIMENTS

To make the above objects, features and advantages of the present disclosure be more obvious and easy to understand, the present disclosure will be further described in detail below in conjunction with the accompanying drawings and particular embodiments.

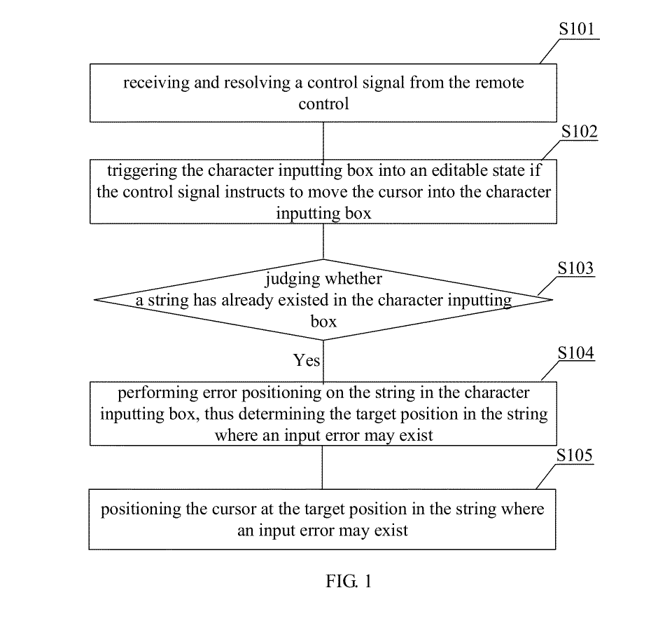

Referring to FIG. 1, it shows a flow diagram of an embodiment of a cursor control method of a smart TV in the present disclosure. In the embodiment of this method, the character inputting box in the character inputting interface is in a non-editing state, i.e., the operations for characters in the character inputting box such as selection, modification and inputting cannot be performed; of course, characters may or may not exist in the character inputting box.

Wherein the case that the character inputting box is in the non-editing state and characters exist in the character inputting box generally corresponds to the situation as follows: the user has input some characters in the character inputting box at some time, and could have moved the operation focus outside the character inputting box after finishing inputting and have executed relevant operations such as clicking “confirmation”; at this time, the character inputting box would automatically enter the non-editing state; although characters have already existed in the character inputting box at this time, the characters existed in the character inputting box would not change due to the operations of the keyboard by the user before the user moves the cursor back into the character inputting box. Alternatively, another situation is that the character inputting box itself may provide a function of storing the strings input by the user, for example, for the information such as the user name used by the user when logging in, with the agreement from the user, the system can record the strings input by the user and may directly display the information about the recorded user name in the input box at the next time when the user logs in the interface again.

The embodiments of the present disclosure are mainly to propose a cursor control method in an embodiment of the present disclosure for above situations.

The method includes steps as follows:

S101, receiving and resolving a control signal from a remote control,

wherein the control signal may be triggered by a key of the remote control and also may be triggered by a touch screen of the remote control;

S102, triggering the character inputting box into an editable state if the control signal instructs to move the cursor into the character inputting box.

S102 includes a step of judging therein, i.e., judging the content of the control signal according to the result of resolving the control signal in S101. In this method, the control signal that needs to be determined is whether to move the cursor into the character inputting box. In particular implementation, the specific meaning of the control signal may be predefined according to a specific scene. For example, in the case of moving the cursor into the region where the character inputting box is, the respective control signal may be determined as the signal “that instructs to move the cursor into the character inputting box” once a signal sent through the key such as the “confirmation” key on the remote control is received again.

If the judgment result is yes, i.e., the control signal is to move the cursor into the character inputting box, triggering the character inputting box into an editable state, i.e., the editing operations for the characters in the character inputting box such as selection, modification and inputting may be performed.

S103, judging whether a string exists in the character inputting box.

In the embodiments of the present disclosure, after receiving the control signal “that instructs to move the cursor into the character”, it is necessary to first judge whether a string exists in the character inputting box, and to turn to S104 if the judgement result is yes, i.e., a string exists in the character inputting box.

The cursor is positioned to the forefront end in the character inputting box if the judgement result is no, i.e., no string exists in the character inputting box; and at this time, the user can input any character as desired and perform successive operations.

S104, performing error positioning on the string in the character inputting box, thereby determining the target position in the string where an input error may exist.

On existing smart TVs, more and more operations need man-machine interaction, and more and more application interfaces need the user to finish operations by inputting characters. For example, it is necessary to input a web address in the interface for logging in the website; it is necessary to input a user name, passwords, verification codes, etc. when the user registers an interface or the user logs in an interface, wherein the user name may be an email address, a mobile phone number, an English word, a string composed of letters and figures, etc.

In an embodiment of the present disclosure, S104 may specifically include the following steps:

determining a string type of the string in the character inputting box according to a preset feature of a certain string type;

wherein the string type may include a mobile phone number, a web address, an email address and the like. A certain type of strings generally has some universality. In the embodiments of the present disclosure, the universality can be extracted and stored as a feature corresponding to some string type. As such, it can be first judged that the string in the character inputting box meets the feature corresponding to which string type and it can be determined that to which type the current string belongs accordingly.

For example, a string is determined to be a mobile phone number if the string meets following features: it is completely composed of figures and begins with FIG. 1, and the length thereof is 11 bits; a string is determined to be a web address if the string begins with “www”, includes multiple fields separated by “.”; and a string is determined to be an email address if the string includes @ therein and includes at least two fields separated by “.” after @.

After determining the type of the string, error positioning is then performed on the string according to a preset error positioning feature corresponding to respective string types.

For example, rightful combinations for the first three figures in a mobile phone number can be listed, thus the white list for the first three figures in the mobile phone number can be preset, e.g., including 130, 131, 132, 133, 134, 135, 189, etc. In case that the type of the string is determined to be a mobile phone number, if the first three figures in the mobile phone number do not match the strings in the white list, error positioning is performed on the first three figures in the mobile phone number so as to determine that the first figures in the mobile phone number may be the target position in the string where an input error may exist.

In a web address, “c”, “o” and “m” or “c” and “n” normally appear in succession. In case that the type of the string is determined to be a web address, if “c”, “o” and “m” or “c” and “n” do not appear in succession in the field (the postfix portion of the web address) in the string separated by the last “.”, for example, some users are often confused with the letter “o” and the number “0” so as to input “c0m” incorrectly when inputting “com”, and at this time the position where the number “0” is in the web address can be determined to be the target position in the string where an input error may exist.

Of course, in addition to above situations, there is also a situation in which error positioning cannot be performed on the string in the character inputting box. In this case, since the error rate for inputting the last few characters is higher than that for inputting the first few characters according to an inputting habit, the right side of the last character in the string is determined to be the target position in the string where an input error may exist.

For example, in case that the string type is determined to be a mobile phone number, and the first three figures in the mobile phone number match the strings in the white list, at this time the smart TV may be unable to judge whether the remaining eight characters of the mobile phone number is right, thus the right side of the last character in the string is determined to be the target position in the string where an input error may exist on this occasion.

S105, positioning the cursor at the target position in the string where an input error may exist, as determined in S104, and performing operations such as deleting, modifying and editing so as to finish correct inputting.

In total, because when the user needs to move the cursor into the character inputting box in which a string exists, some character(s) in the string which is already input often has/have errors, the present disclosure can first determines, in the character inputting interface, the target position in the string where an input error may exist by performing error positioning on the string in the character inputting box, and then positions the cursor at the target position in the string, so that the modification of strings existed in the character inputting box is more convenient, thereby improving modification efficiency and saving input operation cost for users.

Of course, in actual application, wrong judgement may be made in automatic error positioning by the program. Therefore, in particular implementation, in order to avoid inconvenience due to the wrong judgement for users, after the target position in the string where an input error may exist is determined, the method may further includes the following steps: providing a prompt of the information about the target position obtained by error positioning, and asking the user whether it is necessary to move the cursor to the target position.

In particular implementation, the prompt can be displayed on the TV interface via a dialog box which may include a text similar to “whether to move the cursor to the target position?”, a “confirmation” key, a “cancel” key and the like, so that the user performs the next operation according to the actual situation and the prompt in the dialog box.

For example, if the positioning of the error position in the string by the smart TV is correct, click “confirmation”; and if the positioning of the error position in the string by the smart TV is inaccurate, click “cancel”. Accordingly, after the smart TV receives the signal that the user clicks “confirmation”, the operation for displaying the cursor at the target position in the string is triggered; and after the smart TV receives the signal that the user clicks “cancel”, the dialog box is hidden and the cursor is automatically displayed at the right side of the last character in the string, and of course, the cursor may be displayed at other positions.

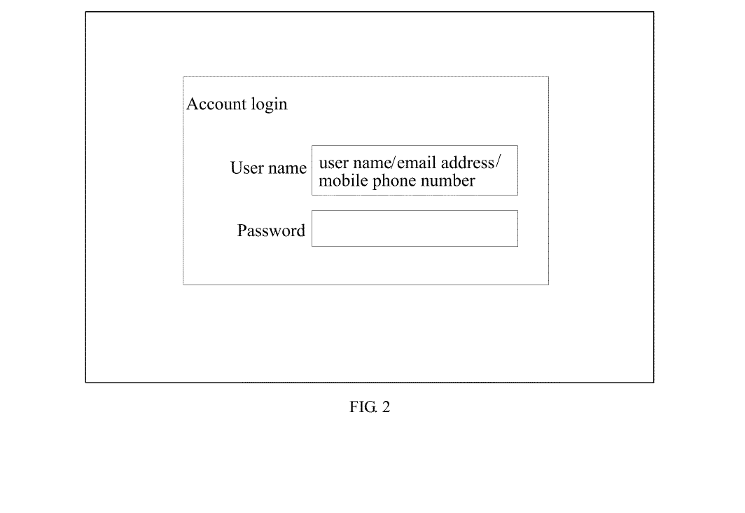

The particular implementation of above embodiments is described below in detail by the way of a specific example and in combination with FIGS. 2, 3 and 4.

Wherein FIGS. 2, 3 and 4 are the first, second and third schematic diagrams of a character inputting interface in the embodiment illustrated in FIG. 1 respectively.

As shown in FIGS. 2, 3 and 4, the character inputting interface is an account login interface in the smart TV, and the characters needed to be input are the user name and the passwords, wherein the user name may be a string composed of letters or composed of letters and figures, an email address or a mobile phone number, any one of which can be selected to input by the user.

In the specific example, the type of the user name selected to input by the user is a mobile phone number, specifically “14501001001”; and after the user input the mobile phone number and the passwords, the character inputting boxes corresponding to the user name and the passwords are transformed into a non-editing state. If the user finds that an error may exist in the input user name at this time, a signal for moving the cursor into the character inputting box corresponding to the user name is sent to the smart TV via the remote control and the character inputting box is triggered into an editable state.

Next, the smart TV performs error positioning on the string in the character inputting box, i.e. performing error positioning on “14501001001” in the character inputting box, so that the target position in “14501001001” where an input error may exist is determined.

The type of the string “14501001001” is first determined according to the preset feature of a certain string type: the characters contained therein are all figures and begin with FIG. 1, and the length of the string is 11 bits, so that the type of the string “14501001001” is determined to be a mobile phone number.

After determining the type of the string, error positioning is performed on “14501001001” according to the preset error positioning feature corresponding to the mobile phone number: the first three figures thereof are “145”, which do not match the string in the white list preset for the first three figures of the mobile phone number, thus the first three figures “145” are determined to be the target position in the string where an input error may exist.

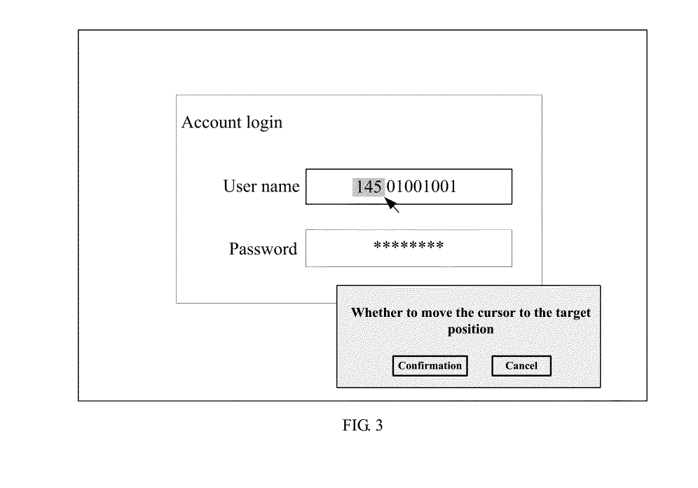

After determining the target position in the string where an input error may exist, the dialog box for asking the user whether it is necessary to move the cursor to the target position is invoked and displayed on the TV interface, and the dialog box includes “whether to move the cursor to the target position?”, a “confirmation” key and a “cancel” key (Referring to FIG. 3).

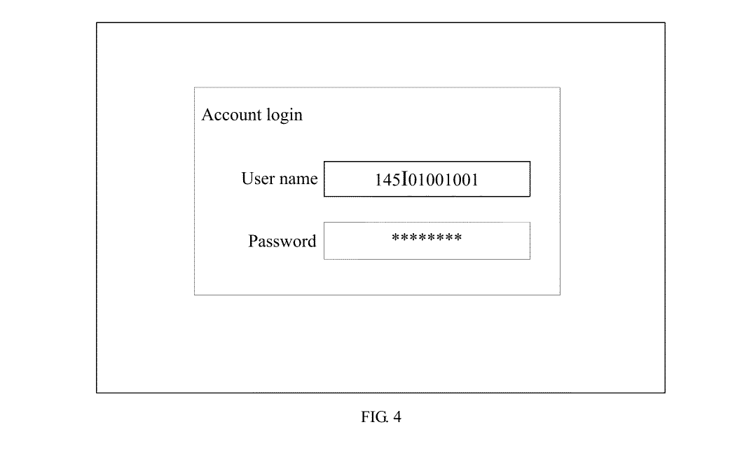

When the user selects the “confirmation” key via the remote control, after the smart TV receives the “confirmation” signal, the cursor is triggered to be displayed at the target position where an input error may exist, i.e., at the position of “145”, and the dialog box is hidden at the same time (Referring to FIG. 4).

If the user thinks that the positioned “target position in the string where an input error may exist” is inaccurate, the “cancel” key is selected via the remote control and the dialog box is hidden after the smart TV receives the “cancel” signal.

The present disclosure further provides a computer-readable recording medium on which a program for executing the method is recorded.

The computer-readable recording medium includes any mechanism which stores or transfers information in a computer (e.g., a computer) readable form. For example, the machine readable medium includes read-only memory (ROM), random-access memory (RAM), magnetic disk storage medium, optical storage medium, flash storage medium, transmission signals in an electrical, optical, acoustic or other forms (such as carrier waves, infrared signals and digital signals) and the like.

The following is a cursor control device corresponding to the aforementioned cursor control method of a smart TV, provided in the present disclosure.

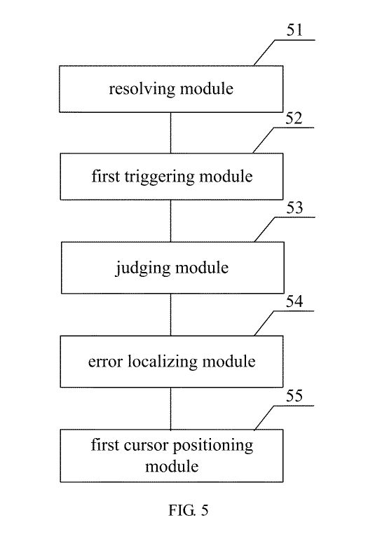

Referring to FIG. 5, it shows a structural schematic diagram of an embodiment of a cursor control device of a smart TV provided in the present disclosure, and in this embodiment of the device, the initial state of the character inputting box in the character inputting interface is in a non-editing state.

The device includes:

a resolving module 51 for receiving and resolving a control signal from a remote control;

wherein the control signal may be triggered by a key of the remote control and also may be triggered by a touch screen of the remote control;

a first triggering module 52 for triggering the character inputting box into an editable state if the control signal instructs to move the cursor into the character inputting box;

The first triggering module 52 can be used for judging the content of the control signal according to the result for resolving the control signal from the resolving module 51. In this method, the control signal that needs to be determined contains whether to move the cursor into the character inputting box.

If the judgment result is to move the cursor into the character inputting box, triggering the character inputting box into an editable state, i.e., the editing operations for the characters in the character inputting box such as selection, modification and inputting may be performed;

a judging module 53 for determining whether a string exists in the character inputting box;

an error positioning module 54 for performing error positioning on the string in the character inputting box if the judgement result from the judging module 53 is yes, thereby determining a target position in the string where an input error may exist;

a first cursor positioning module 55 for positioning the cursor at the target position in the string.

The cursor control device of a smart TV provided in the present disclosure can first determines, in the character inputting interface, the target position in the string where an input error may exist by performing error positioning on the string in the character inputting box, and then positions the cursor at the target position in the string, so that the modification of strings existed in the character inputting box is more convenient, thereby improving modification efficiency, providing convenience for user operations and thus improving experiences for users.

In an embodiment of the present disclosure, the error positioning module 54 may specifically include:

a string type determining module for determining a string type of the string in the character inputting box according to a preset feature of a certain string type;

a string error positioning module for performing error positioning on the string according to the error positioning feature corresponding to respective preset string type.

Of course, in addition to above situations, there is also a situation in which error positioning cannot be performed on the string in the character inputting box; on this basis, the error positioning module 54 is further used for determining the right side of the last character in the string as the target position in the string where an input error may exist.

In a further embodiment of the present disclosure, the device further includes:

a prompting module for providing a prompt of the information about the target position obtained from the error positioning to the user and asking the user whether it is necessary to move the cursor to the target position;

a second triggering module for triggering an operation of displaying the cursor at the target position in the string when a confirmation message is received from the user.

In an embodiment of the present disclosure, the device further includes:

a second cursor positioning unit for positioning the cursor at the forefront end in the character inputting box when the judgement result from the judging module is no.

Each embodiment in this specification is described in a progressive way, and focuses on differences from other embodiments. The similar parts among embodiments can be referred to each other. For the embodiments of the device, the description is simple as they are basically similar to the embodiments of the method, and the related parts can be referred to the partial description of the embodiments of the method.

The above describes in details a cursor control method and cursor control device of a smart TV provided according to the present disclosure. In this paper, the specific examples are used to describe the principle and the embodiments of the present disclosure. The description on the embodiments as above is used only to help understanding the methods and its core ideas of the present disclosure; meanwhile, ordinary technical personnel skilled in the art can accord to the idea of the present disclosure to modify the concrete embodiments and the application scope. In summary, the contents in the specification shall not be understood as any limit on the present disclosure.

1. A cursor control method of a smart TV, characterized in that, when a character inputting box in a character inputting interface is in a non-editing state, said method comprises:
receiving and resolving a control signal from a remote control;
triggering said character inputting box into an editable state if the control signal instructs to move a cursor into said character inputting box;
judging whether a string exists in said character inputting box;
performing error positioning on the string in said character inputting box if the judgement result is yes, thus determining a target position in said string where an input error may exist; and
positioning said cursor at said target position in the string.

2. The cursor control method according to claim 1, characterized in that, the method further comprises:
positioning said cursor at the forefront end in said character inputting box if the judgment result is no.

3. The cursor control method according to claim 1, characterized in that, said performing error positioning on the string in the character inputting box further comprises:
determining a string type of said string in said character inputting box according to a preset feature of a certain string type; and
performing error positioning on said string according to said error positioning feature corresponding to respective preset string type.

4. The cursor control method according to claim 3, characterized in that, before positioning said cursor at said target position in said string, the method further comprises:
providing a prompt of the information about said target position obtained from the error positioning to a user and asking said user whether it is necessary to move said cursor to said target position; and
triggering an operation of displaying said cursor at said target position in the string if a confirmation message is received from said user.

5. The cursor control method according to claim 3, characterized in that, said performing error positioning on said string contained in said character inputting box further comprises:
determining that the right side of the last character in said string is said target position.

6. The cursor control method according to claim 1, characterized in that, said control signal is triggered by a key on said remote control or triggered by a touch screen of said remote control.

7. A smart TV, characterized in that, an initial state of a character inputting box in a character inputting interface is in a non-editing state,
said smart TV comprises:
a memory having instructions stored thereon;
a processor configured to execute the instructions to perform operations of cursor control, comprising:
receiving and resolving a control signal from a remote control;
triggering said character inputting box into an editable state if the control signal instructs to move a cursor into said character inputting box;
judging whether a string exists in said character inputting box;
performing error positioning on said string in said character inputting box if the judgement result is yes, thereby determining a target position in said string where an input error may exist; and
positioning said cursor at said target position in said string.

8. The smart TV according to claim 7, characterized in that, the processor is further configured to perform:
determining module for determining a string type of said string in said character inputting box according to a preset feature of a certain string type; and
performing error positioning on the string according to the error positioning feature corresponding to respective preset string type.

9. The smart TV according to claim 8, characterized in that, the processor is further configured to perform:
providing a prompt of the information about said target position obtained from the error positioning to said user and asking said user whether it is necessary to move said cursor to said target position; and
triggering an operation of displaying said cursor at said target position in said string if a confirmation message is received from said user.

10. The smart TV according to claim 8, characterized in that, in the performing error positioning on said string in said character inputting box if the judgement result is yes, thereby determining a target position in said string where an input error may exist, the processor is further configured to perform:
determining that the right side of the last character in said string is said target position.

11. A non-transitory computer-readable recording medium having computer programs stored thereon that, when executed by one or more processors of a smart TV, cause the smart TV to perform:
receiving and resolving a control signal from a remote control;
triggering said character inputting box into an editable state if the control signal instructs to move a cursor into said character inputting box;
judging whether a string exists in said character inputting box;
performing error positioning on the string in said character inputting box if the judgement result is yes, thus determining a target position in said string where an input error may exist; and
positioning said cursor at said target position in the string.
